(19) United States
(12) Patent Application Publication
(10) Pub. No.: US 2015/0019524 A1
(43) Pub. Date: Jan. 15, 2015

(54) ASSIGNMENT OF DESIGNATIONS FOR MEASUREMENT SIGNALS AND DEVICES FROM A FIRST IDENTIFICATION SYSTEM TO A SECOND IDENTIFICATION SYSTEM WITHIN PROJECT PLANNING FOR A TECHNICAL INSTALLATION

(71) Applicant: Siemens Aktiengesellschaft, Munich (DE)

(72) Inventors: Thorsten Fuhring, Munchen (DE); Andreas Geiger, Rulzheim (DE); Klaus Wendelberger, St. Leon-Rot (DE)

(73) Assignee: SIEMENS AKTIENGESELLSCHAFT, Munich (DE)

(21) Appl. No.: 14/374,900

(22) PCT Filed: Feb. 1, 2013
(86) PCT No.: PCT/EP2013/052028

§ 371 Date: Jul. 26, 2014

(30) Foreign Application Priority Data
Feb. 1, 2012 (DE) 102012201451.9

(51) Int. Cl. G06F 17/30

(52) U.S. Cl. CPC G06F 17/30663; G06F 17/30867; G06F 17/30684
USPC 707/708

(57) ABSTRACT

A method and device for assigning measurement signal and device designations from a first to a second classification system within a projection of a technical system is provided. The process is implemented in an automated manner by a search engine. A measurement signal or device designation from the first classification system is entered into the search engine and converted into a search query. The text elements of the search query are processed, wherein text elements are semantically analyzed using terminology and compared with those of a list which contains all the designations from the second classification system. The text elements from the list which best match those of the search query are evaluated with respect to relevance and outputted as search results of the search engine. The search result with the maximum relevance corresponds to the designation from the second classification system and replaces designation from the first classification system.

### CROSS REFERENCE TO RELATED APPLICATIONS

This application is the US National Stage of International Application No. PCT/EP2013/052028 filed Feb. 1, 2013, and claims the benefit thereof. The International Application claims the benefit of German Application No. DE 102012201451.9 filed Feb. 1, 2012. All of the applications are incorporated by reference herein in their entirety.

### FIELD OF INVENTION

The invention relates to a method for assigning designations for measurement signals and devices from a first identification system to a second identification system within project planning for a technical installation, to an apparatus that is designed to carry out the method and to a computer program product.

### BACKGROUND OF INVENTION

Project planning for relatively high-grade process control engineering functions in process automation is very complex and susceptible to error, in principle.

The term project planning is used in installation construction or in automation engineering usually for the creation of technical (or other) documents for representing processes, e.g. process engineering processes such as the combustion of fossil fuels in power stations. Project planning arises whenever changes need to be made within a technical installation. It is then necessary for newly added units to be interconnected, for example, and the process control engineering needs to be adjusted accordingly.

The concept of process control engineering functions generally comprises:—The function diagrams of the control and regulation systems, which show what measured variables are used and how these are processed algorithmically in order to ascertain how the drives (valves, flaps, motors, etc.) need to be moved.—The operator control images, which are used to provide the installation operator with information about the current state of the installation and which said installation operator can use to take control actions.—The descriptions, in which the functionality of the automation functions is explained verbally.

One of the most efficient methods of lowering the complexity for creating these documents and improving quality is standardization. The repeated use of an already existing template, i.e. from a standard, for a function diagram, an operator control image and/or a description ensures that—firstly the relevant project planning complexity is significantly reduced, since it is possible to resort to an already existing template,—and secondly the quality of the project planning is significantly increased, since this involves resorting to documents that have already proved themselves in a plurality of projects. A method for automated project planning for process control engineering for a technical installation that involves the use of standardization for creating project planning documents is known from WO 2012/104403 A1.

In power plant engineering, all the measured variables, devices or drives are designated by a unique name, what is known as the identification. Various identification systems have been developed that are used with greater or lesser frequency in various countries of the earth. Furthermore, each measured variable and each drive is provided with a short text that describes what measured variable/what drive is involved. According to the KKS system (power plant identification system) predominantly used in Germany, the power of a generator could be designated by A OMKA01 CE001 as the unique identification and P Gen as the descriptive short text, for example.

In projects in which standards are used too, the measured variables and drives used need to be designated uniquely. In order to be actually able to use a standard in a real project, the project manager needs to replace the dummy identifications and short texts from the standards with project-specific identifications/short texts. By way of example, the standard states that in order to regulate the generator power it is necessary to compare the measured power A OMKA01 CE001/P GEN with a setpoint value and to connect the resultant control difference to an input of a regulator. The user of the standard then needs to clarify what the designation for measurement of the generator power in his project actually states. By way of example, the project-specific designation could be “1 OMKA10 CE102/Lstg Generator”. The user needs to adjust the designation as appropriate so that ultimately the correct measured variable is used in the real project.

Ultimately, the user thus has the task of finding the correct project-specific designations for each measurement or for each drive that is addressed in the standards. The necessary information is found in a list that shows all the measured variables and/or all the drives that occur in the relevant power plant. Since such a list usually has several thousand entries, this is a very complex task, in principle, to assign the designations used in the standard to the project-specific designations. This applies particularly when the standard and the project have different identification systems, i.e. when the dummy identification of the standard and the project-specific identification differ so greatly that it is not possible to use a simple search function in the list to jump to a similar identification. In many identification systems, the identification itself contains only little or indeed no information about what kind of variable is actually involved. It may thus be necessary to use the information from the short text to search for the correct entry in the measurement point or drive list. This in turn is associated with great complexity.

The search for project-specific designations for measurements and drives has been performed manually to date, which signifies an enormous time involvement. Usually, the measurement point and drive lists are in digital form, e.g. in the format of a spreadsheet program such as Excel or Access. The manual search can then be assisted by the functions of the relevant program. In the example cited above, it would be possible to search for “MKA?? CE”, for example, in Excel. In the KKS system, MKA designates the generator and CE designates the measurement of an electrical variable. As expected, this allows the search to be narrowed down to 10-30 entries, for example, in the measurement point list. If a different identification system is used in the real project than in the standards, this approach is not possible, because the differences between the identification systems used are too great. It may be possible for the user to translate the identification to the other system and then use the normal search function again. In extreme cases, only the search using the short text is left.

### SUMMARY OF INVENTION

It is an object of the present invention to specify a method that, within the context of project planning for a technical installation, assigns the designations for measurement signals and/or devices from a first identification system to a second identification system in automated fashion, so that the project planning can be performed more quickly. A further object of the invention is to specify a corresponding apparatus that supports this method. In addition, it is an aim to specify a corresponding computer program product.

These objects are achieved by the features of the independent patent claims. Advantageous refinements are respectively reproduced in the dependent patent claims.

The advantage of the invention is a considerable time saving accompanied by a considerable cost saving for the handling of process control engineering projects in which standards are used. The method according to the invention allows fully automatic replacement of the dummy designations from the standards with the project-specific designations. The manual work is then dispensed with completely at this juncture, which simultaneously results in a decrease in the error rate and hence an increase in quality.

### BRIEF DESCRIPTION OF THE DRAWINGS

The invention is explained in more detail below with reference to a drawing and an exemplary embodiment. In the drawing:

FIG. 1 shows an outline to explain the invention,

FIG. 2 shows an extract from the terminology for the term “valve”.

### DETAILED DESCRIPTION OF INVENTION

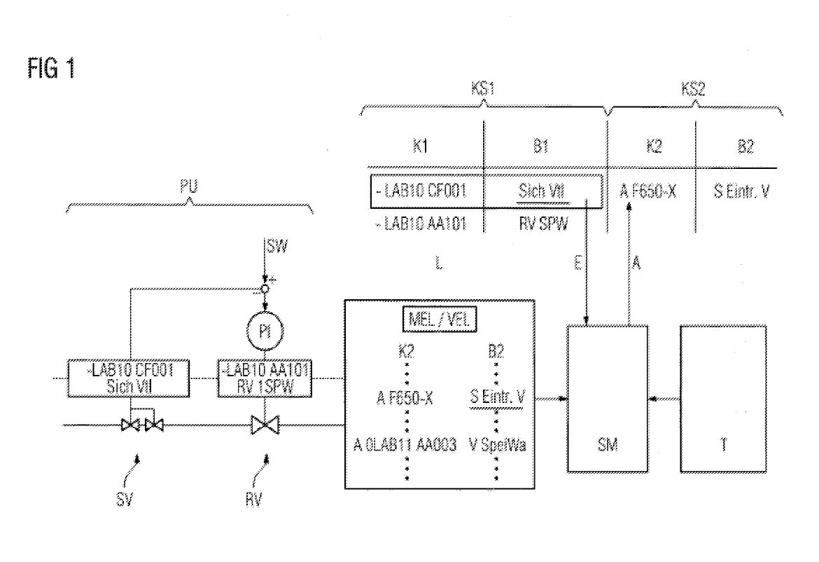

FIG. 1 shows a detail from a project planning document PU for a technical installation. In this case, the project planning document PU is meant to have been created by means of a standard.

A project planning document PU may in this case be—a function diagram, particularly a regulation system function diagram (also just regulation function diagram for short), or a control function diagram for a component, for example for a drive, a valve, a flap, a motor or the like in a technical installation,—an operator control interface (operator control image) for a technical installation and/or—a description, particularly a textual description, for a technical installation, particularly a description of a functionality of a technical installation.

In the exemplary embodiment shown, the project planning document produced by means of a standard comprises a process engineering installation image for flow regulation. A setpoint value SW is used to set the flow through a regulatory valve RV. The regulatory valve RV bears the dummy identification “LAB10 AA101” as a designation and is described with the short text “RV 1SPW”, which contains the abbreviations “RV” and “SPW”, for example, for regulatory valve and feed water pump, respectively, and a number. In this case, the regulatory valve RV has two redundantly connected safety valves SV connected upstream of it, which likewise bear designations that are prescribed within the standard: by way of example, the dummy identification “LAB10 CF001” and the descriptive short text “Sich Vtl”. In order to actually be able to use a standard in a real project, the invention will now be used to replace the designations for measurement signals and devices from the standards with the project-specific designations. The term designations covers both identifications and short texts or short descriptions as are used frequently in installation construction for description purposes. By way of example, the identifications originate from the KKS system (power plant identification system). However, other identification systems can also be used, depending on the country.

The designations for measurement points and devices from a first identification system KS1 will now be assigned to the designations from a second identification system KS2, and replaced by the latter, in automated fashion. To this end, the designations of the standard are input into a search engine SM. The inventive search engine SM combines techniques that are also used in conventional text search engines with simple but robust analysis techniques and has furthermore been specifically tailored to the underlying specialty of installation construction.

In the example shown in FIG. 1, the first identification system KS1 contains the identifications K1 and descriptions B1 for the designation of the regulatory valve RV and the safety valves SV from the project planning document. By way of example, the input E in the search engine may now comprise the short text “Sich Vtl” and/or the designation LAB10 CF001 as a search term.

Within the search engine SM, the input E is subjected to text preprocessing in a first step. From the input text, what is known as a “regular expression” is formed, i.e. a character string that is used to describe sets of character strings using particular syntactic rules. Such expressions can be used as filter criteria in the text search, and it is particularly possible for complicated text replacements to be performed. This breakdown into compound words then results in individual text elements that are subsequently semantically analyzed in a second step—when the search query is handled.

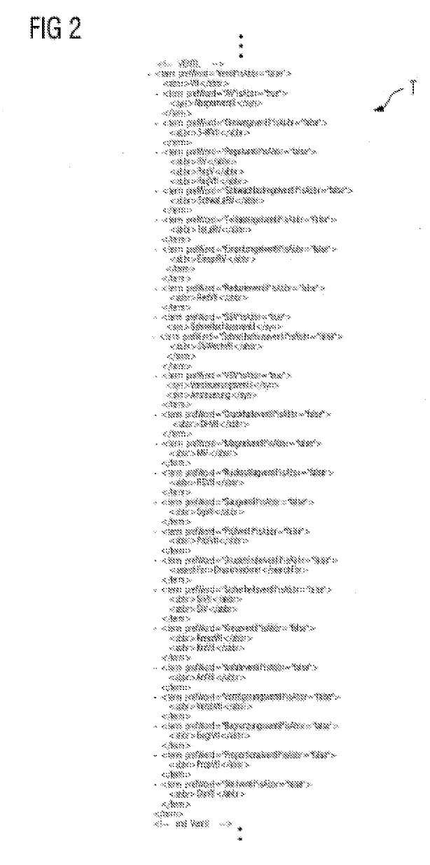

The semantic text analysis takes place on the basis of the terminology T. The search query is accordingly expanded (“Query Expansion”) in order to find subterms and related terms. In this case, the terminology T is specifically tailored to the terms used here from process control engineering and installation construction. The terminology T is a data structure that is connected to the search engine SM and is used for a later search query. An extract from the terminology T used for this exemplary embodiment is shown in FIG. 2. Before the search engine SM is used, the data structure of the terminology T needs to be read or loaded into the search engine SM.

The terminology T is used to define all the terms arising in a measurement point or drive list and also all the—synonyms,—abbreviations,—subterms (e.g. feed pump and oil pump as subterms of pump),—alternative search terms (e.g. full load pump and turbopump are not genuine synonyms. However, they could be used alternatively. If one term is not found, the other still needs to be sought) and—alternative phrases associated with the respective term.

In this case, the semantic text analysis is capable—of working with synonyms (e.g. vertical position and level have the same meaning),—of interpreting abbreviations (e.g. Temp or T as an abbreviation of temperature),—of breaking down compound words, including in connection with abbreviations (e.g. PreSli is broken down into Pre and Sli and means pressure and slider),—of dealing with incorrectly used terms (e.g. quantity and mass flow have the same meaning, even though physically they are different variables),—of dealing with typing errors (e.g. with the use of the term “tmeperature” instead of temperature),—of dealing with phrases that have the same meaning (e.g. “downstream of tank” and “upstream of turbine” have the same meaning),—of interpreting letters, numbers and strings (e.g. when analyzing the term “Temp hi pump 1”),—of interpreting both a numerical count and a count with letters (e.g. both the term “pump 1” and the term “pump A” each denote the first pump), and—of being used for terms in any western language.

In the exemplary embodiment shown in FIG. 1, the search term “Sich Vtl” is broken down into the individual text elements “Sich” and “Vtl” during the text preprocessing, for example. These text elements are then semantically analyzed using the terminology T and processed. In this case, the result of this analysis is that the search query is directed at safety valves. The search engine SM now knows that it now needs to search a list L, which contains the designations from the second identification system KS2 (usually project-related designations for measurement points, measurement signals and devices), for the text elements that are related to safety valves. By way of example, it finds the entry “S Eintr. V” in this case for the descriptions B2 with the designation K2 “A F650-X” from the second identification system KS2.

This means that the search engine SM is furthermore connected to a further data structure. This is the list L with the designations for the measurement signals and devices from the second identification system KS2. In this exemplary embodiment, this list L is designated as measurement point and load list MEL/VEL for the project. The individual representations from the list L and those from the search query are compared with one another in a subsequent step and rated in terms of their relevance (comparison of the query representation and the text representation). This is done using what is known as the cosine method, also referred to as cosine similarity. This involves forming the cosine from the quotient that consists of the number of common elements divided by the total number of elements. This similarity measure is then weighted on the basis of the search query length, which produces a rating scale for the hits that result from the semantic text analysis. This “scoring” accordingly involves hits being rated for their relevance to the search query and the best hits being displayed at the top of the hits list. This allows search queries to be automatically formulated such that a very large number of hits is generated, only some of which are relevant. This allows the system to deliver good results regardless of the different forms of the measurement point and drive lists.

The search result with maximum relevance therefore corresponds to the designation for a measurement signal or device from the second identification system KS2. This can now replace the designation from the first identification system KS1.

On the basis of the details in the terminology T, the system is capable of recognizing, by way of example, that the term “Temp hi pmp 1” has the same meaning as the term “T downstream of pump A”. Following semantic analysis of the short texts, the corresponding entry in the measurement point or drive list can then be found for a prescribed search term (dummy short text from a standard).

Matches that are found are weighted in this case. The match between pmp and pump has a higher weight than the match between hi and downstream of, for example.

If possible, information from the identification of the measurement or the drive is also evaluated during the search. The match between the contents of two short texts is provided with a higher rating if there is simultaneously also a match for the identifications.

Erroneous search results (the correct entry in the measurement point or drive list is not found or an incorrect entry is found) can be used to have expansion or improvement of the terminology T performed automatically.

The system accordingly combines methods of “information extraction” with conventional text searches. Conventional text searches usually involve entire words, as occur in the text, being used as searchable units, in most cases without breakdown of compound words. Some systems also indicate particular text elements that can be identified by means of their syntax, such as e-mail or IP addresses. By contrast, the system presented here uses the terminology T in order to identify the text elements that are important for the research. In order to be able to deal with imprecise or incomplete texts and queries, techniques that are applied in text search engines are resorted to. The inventive search engine SM will search a list (measurement point or drive list) for the appropriate term that has the same meaning in this content. Unlike in the case of a pure full text search, this search may be successful even when the search term and the term to be found have similar strings.

1. A method for assigning designations for measurement signals and/or devices from a first identification system (KS1) to a second identification system (KS2) within project planning for a technical installation, the method comprising:
effecting the assignment in automated fashion by a search engine (SM) wherein
a designation (K1, B1) for a measurement signal or device from the first identification system (KS1) is input into the search engine (SM),
the designation (K1, B1) is converted into a search query by analyzing it and breaking it down into individual text elements,
the text elements of the search query are processed by semantically analyzing them by a terminology (T) and comparing them with text elements in a list (L) that contains all the designations (K2, B2) for measurement signals and devices from the second identification system (KS2),
the text elements from the list (L) having the greatest matches with the text elements in the search query are rated for their relevance and output as a search result from the search engine (SM), and
the search result with maximum relevance as a designation (K2, B2) for a measurement signal or device from the second identification system (KS2) is assigned to the designation (K1, B1) for a measurement signal or device from the first identification system (KS1).

2. The method as claimed in claim 1, wherein
the terminology (T) comprises definitions of all the terms arising in a measurement point and/or drive list and all the synonyms, abbreviations, subterms, alternative search terms and alternative phrases that are associated with the respective terms.

3. The method as claimed in claim 1, wherein
prior to the first search query the terminology (T) is read into the search engine (SM) a single time.

4. The method as claimed in claim 1, wherein
matches that are found are weighted.

5. The method as claimed in claim 1, wherein
erroneous search results are used to improve the terminology (T).

6. The method as claimed in claim 1, wherein
a designation for a measurement signal or device comprises both an identification (K1, K2) and a descriptive short text (B1, B2).

7. An apparatus for assigning designations for measurement signals and devices from a first identification system (KS1) to a second identification system (KS2) within project planning for a technical installation, comprising:
a project planning module for producing a specific project planning document (PU) for process control engineering, for which project planning is to be performed, in a technical installation and
a search engine (SM) that is coupled to a module for semantic text analysis in which a method as claimed in claim 1 is implemented.

8. A non-transitory computer program product having a computer program that is loaded into the memory of a computer and comprises software code sections that are used to execute the steps as claimed in claim 1 when the computer program runs on a computer.
